(19) United States
(12) Patent Application Publication
(10) Pub. No.: US 2021/0208749 A1
(43) Pub. Date: Jul. 8, 2021

(54) NON-TRANSITORY COMPUTER READABLE MEDIUM STORING PROGRAM FOR ADDING NEW ICONS TO A DISPLAY

(71) Applicant: FUJI XEROX CO., LTD., Tokyo (JP)

(72) Inventors: Tsuyoshi TODA, Kanagawa (JP); Hideaki SUGIMOTO, Kanagawa (JP); Takafumi HARUTA, Kanagawa (JP); Shinichi NAKAMURA, Kanagawa (JP); Nozomi NOGUCHI, Kanagawa (JP)

(73) Assignee: FUJI XEROX CO., LTD., Tokyo (JP)

(21) Appl. No.: 17/210,909

(22) Filed: Mar. 24, 2021

Related U.S. Application Data
(63) Continuation of application No. 14/925,430, filed on Oct. 28, 2015.

(30) Foreign Application Priority Data
May 7, 2015 (JP) 2015-095213

(51) Int. Cl. G06F 3/0482; H04N 1/00; G06F 3/0488

(52) U.S. Cl. CPC G06F 3/0482; H04N 1/00; H04N 1/00474; G06F 3/04886; H04N 1/00501; H04N 1/00405; H04N 1/00437; H04N 1/0035; H04N 1/00424; H04N 1/00503

(57) ABSTRACT

Provided is a non-transitory computer readable medium storing a program causing a computer to execute a process, the process including receiving an addition instruction operation to instruct addition of a new display element to a screen in which plural display elements are arranged, and displaying, when the addition instruction operation is received, the screen in which the new display element is added in a position adjacent to a predetermined side of a reference display element, the reference display element being a display element which is a reference among the plural display elements.

### CROSS-REFERENCE TO RELATED APPLICATIONS

This application is a Continuation of U.S. application Ser. No. 14/925,430 filed Oct. 28, 2015, which is based on and claims priority under 35 USC 119 from Japanese Patent Application No. 2015-095213 filed May 7, 2015.

### BACKGROUND

### Technical Field

The present invention relates to a non-transitory computer readable medium storing a program.

### SUMMARY

According to an aspect of the invention, there is provided a non-transitory computer readable medium storing a program causing a computer to execute a process, the process including:

receiving an addition instruction operation to instruct addition of a new display element to a screen in which plural display elements are arranged; and

displaying, when the addition instruction operation is received, the screen in which the new display element is added in a position adjacent to a predetermined side of a reference display element, the reference display element being a display element which is a reference among the plural display elements.

### BRIEF DESCRIPTION OF THE DRAWINGS

Exemplary embodiments of the present invention will be described in detail based on the following figures, wherein:

FIG. 1 is a diagram illustrating a hardware configuration example of an image processing apparatus of an exemplary embodiment of the present invention;

FIGS. 2A and 2B are diagrams respectively illustrating examples of menu screen in which icons are arranged in a Z order and in a reverse N order;

FIG. 3 is a block diagram illustrating a functional configuration example of a screen display apparatus of an exemplary embodiment of the present invention;

FIG. 4 is a diagram illustrating an example of screen information stored in a screen information storage unit of an exemplary embodiment of the present invention;

(a) to (d) of FIG. 5 are diagrams illustrating an outline of a first exemplary embodiment;

FIG. 6 is a flowchart illustrating an operation example of a screen display apparatus of the first exemplary embodiment;

(a) to (d) of FIG. 7 are diagrams illustrating an outline of a second exemplary embodiment;

FIG. 8 is a flowchart illustrating an operation example of a screen display apparatus of the second exemplary embodiment;

(a) to (d) of FIG. 9 are diagrams illustrating an outline of a third exemplary embodiment;

FIG. 10 is a flowchart illustrating an operation example of a screen display apparatus of the third exemplary embodiment;

(a) to (d) of FIG. 11 are diagrams illustrating an outline of a fourth exemplary embodiment;

FIG. 12 is a flowchart illustrating an operation example of a screen display apparatus of the fourth exemplary embodiment;

(a) to (d) of FIG. 13 are diagrams illustrating an outline of a fifth exemplary embodiment;

FIG. 14 is a flowchart illustrating an operation example of a screen display apparatus of the fifth exemplary embodiment;

(a) to (d) of FIG. 15 are diagrams illustrating an outline of a sixth exemplary embodiment;

FIG. 16 is a flowchart illustrating an operation example of a screen display apparatus of the sixth exemplary embodiment;

(a) to (c) of FIG. 17 are diagrams illustrating an outline of a seventh exemplary embodiment; and

FIG. 18 is a flowchart illustrating an operation example of a screen display apparatus of the seventh exemplary embodiment.

### DETAILED DESCRIPTION

Hereinafter, exemplary embodiments of the present invention will be described in detail with reference to the accompanying drawings.

Hardware Configuration of Image Processing Apparatus

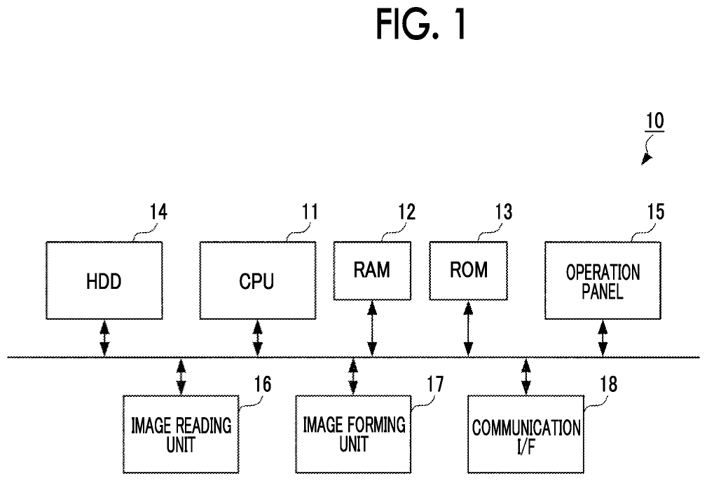

FIG. 1 is a diagram illustrating a hardware configuration example of an image processing apparatus 10 of the present exemplary embodiment. As illustrated in FIG. 1, the image processing apparatus 10 include a central processing unit (CPU) 11, a random access memory (RAM) 12, a read only memory (ROM) 13, a hard disk drive (HDD) 14, an operation panel 15, an image reading unit 16, an image forming unit 17, and a communication interface (hereinafter, referred to as “communication I/F”) 18.

The CPU 11 realizes the functions described below, by loading various programs stored in the ROM 13 and the like into the RAM 12 and executing the loaded programs.

The RAM 12 is a memory that is used as a working memory of the CPU 11.

The ROM 13 is a memory that stores various programs and the like that the CPU 11 executes.

The HDD 14 is, for example, a magnetic disk device that stores image data that the image reading unit 16 reads, image data used in image formation by the image forming unit 17, and the like.

The operation panel 15 is, for example, a touch panel that displays various types of information and receives the operation input from the user. Here, the operation panel 15 includes a display that displays various types of information, and a position detection sheet that detects the position indicated by the finger, a stylus pen, or the like. Alternatively, a display and a keyboard may be used instead of the touch panel.

The image reading unit 16 reads an image recorded on a recording medium such as paper. Here, the image reading unit 16 is, for example, a scanner, and a CCD type scanner in which a lens reduces the reflection light for light that is applied to a document from a light source and a charge coupled device (CCD) receives the reduced light, or a CIS type scanner in which a contact image sensor (CIS) receives the reflection light for light that is applied in order, to a document from an LED light source may be used.

The image forming unit 17 forms an image on a recording medium. Here, the image forming unit 17 is, for example, a printer, and an electrophotographic type printer that forms an image by transferring a toner adhered to a photosensitive body to a recording medium, or an ink jet printer that forms an image by ejecting ink on a recording medium may be used.

The communication I/F 18 transmits and receives various types of information with another device through a communication circuit (not illustrated).

Functional Configuration of Screen Display Apparatus

In the present exemplary embodiment, in such the image processing apparatus 10, a screen display apparatus 20 displays a menu screen in which multiple icons are aligned in a tile shape, on the operation panel 15. Here, each icon expresses a thing as a visually abbreviated symbol, and is intended to control a computer action. The icon may be configured with only a picture, or only a character, or may be configured with a picture and a character.

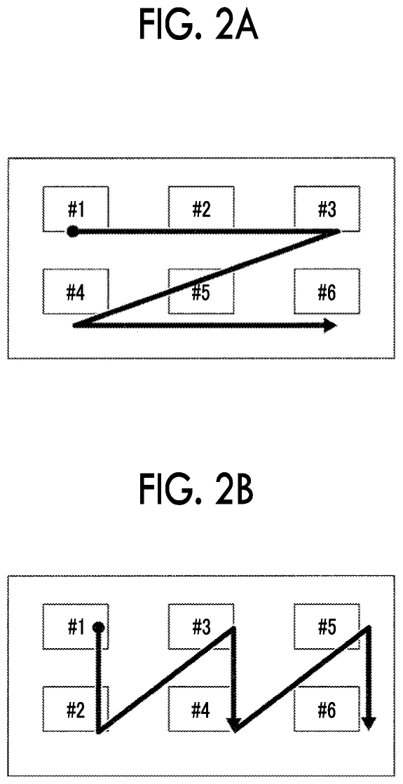

The icons are arranged in a Z order or in a reverse N order. FIG. 2A illustrates an example of a menu screen in which icons are arranged in a Z order, and FIG. 2B illustrates an example of a menu screen in which icons are arranged in a reverse N order. A small square represents an icon, and an icon labeled #K″ (hereinafter, referred to as “icon #K”) among icons represents a K-th icon. In other words, in FIG. 2A, icons are arranged in an order from the left to the right on the top row, and from the left to the right on the following row. In FIG. 2B, icons are arranged in an order from the upper end to the lower end on the leftmost column, from the upper end to the lower end on the next right column, and from the upper end to the lower end on the next right column. Further, in the present exemplary embodiment, icons are arranged as an example of a display element, but objects other than the icon may be arranged.

Further, there is a case where the menu screen is scrolled in a vertical direction, or a case where the menu screen is scrolled in a horizontal direction. For example, the menu screen of FIG. 2A may be scrolled in the vertical direction, the menu screen of FIG. 2B may be scrolled in the horizontal direction. Further, in the present exemplary embodiment, the menu screen is displayed as an example of a screen, and a screen other than the menu screen may be displayed.

Further, in the menu screen, icons may not be arranged in specified positions (margins are allowed at the specified positions), and the icons may be need to be arranged in specified positions (margins are not allowed at the specified positions). Then, the arrangement order of respective icons is changed by drag and drop.

In this manner, various variations are present depending on the order of icons and the scroll direction and presence or absence of the margin on the menu screen, but in the following description, a menu screen is assumed in which icons are arranged in the Z order, is scrolled in the vertical direction, the margins of the specified position are not allowed. Then, the screen display apparatus 20 adds an icon on the menu screen in response to the user instruction.

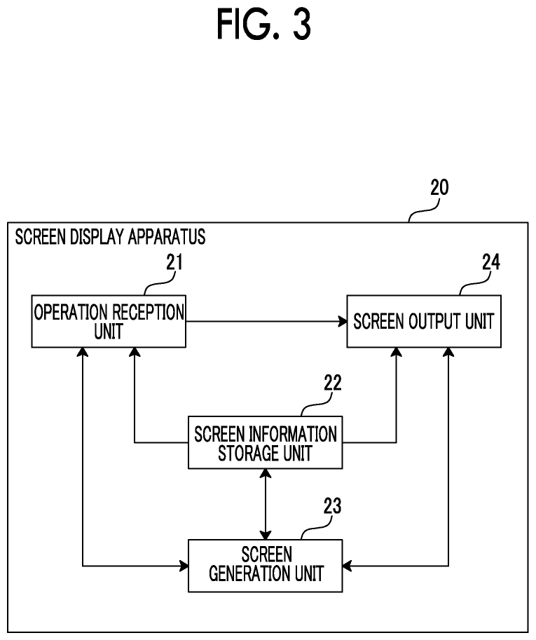

FIG. 3 is a block diagram illustrating a functional configuration example of the screen display apparatus 20. Here, the screen display apparatus 20 is regarded as a device that is realized by the CPU 11 (see FIG. 1) of the image processing apparatus 10 reading a program for realizing each functional unit to be described later from, for example, the ROM 13 (see FIG. 1) into the RAM 12 (see FIG. 1) and executing the program. As illustrated in FIG. 3, the screen display apparatus 20 includes an operation reception unit 21, a screen information storage unit 22, a screen generation unit 23, and a screen output unit 24.

The operation reception unit 21 receives a user operation on the operation panel 15. Here, the user operation includes an operation of designating a position to add an icon on the menu screen, as an example of a position designation operation. Further, the user operation includes an operation of copying the icon that has been placed on the menu screen, as an example of a copy operation. Further, the user operation includes an operation of placing the copied icon or an operation of selecting an icon on the icon adding screen, as an example of an addition instruction operation. In the present exemplary embodiment, the operation reception unit 21 is provided as an example of a reception unit that receives the position designation operation, the copy operation, the addition instruction operation, and the like.

The screen information storage unit 22 stores information for generating a menu screen (hereinafter, referred to as “screen information”). In addition, the screen information will be described in detail later.

The screen generation unit 23 generates a menu screen displayed on the operation panel 15, using the screen information stored in the screen information storage unit 22. At this time, when there is the operation of placing the copied icon, or the operation of selecting an icon on the icon adding screen, the screen information stored in the screen information storage unit 22 is updated, and an icon added menu screen is generated using the updated screen information. Further, when there is the operation of designating a position to add an icon on the menu screen, a menu screen is generated in which an icon is added to the designated position; and when there is no operation of designating a position to add an icon on the menu screen, a menu screen is generated in which an icon is added to a position that is determined according to a predetermined rule.

The screen output unit 24 output the menu screen that is generated by the screen generation unit 23, to the operation panel 15. In the present exemplary embodiment, the screen output unit 24 is provided as an example of a display unit that displays a screen in which a new display element is added.

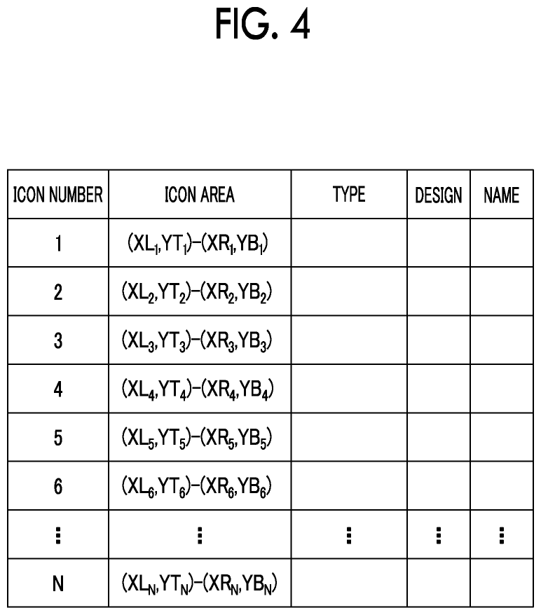

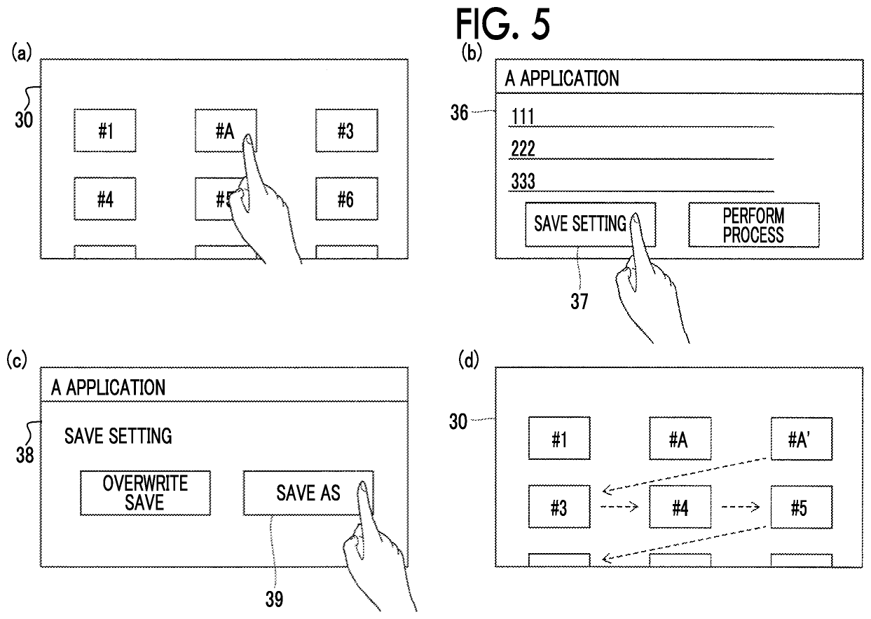

Here, the screen information stored in the screen information storage unit 22 will be described. FIG. 4 is a diagram illustrating an example of the screen information. As illustrated in FIG. 4, the screen information includes an icon number, an icon area, a type, a design, and a name. Further, the screen information includes not only information about an icon but also information about a screen in which icons are arranged, but here, only the information about an icon is displayed.

The icon number is a value indicating the arrangement order of the icon on the menu screen. In terms of the example of FIG. 2A, the icon number corresponds to #1 to #6 indicated in the icons.

The icon area is an area in which an icon is placed on the menu screen. In the present exemplary embodiment, for ease of explanation, the icon is a square, and the icon area is expressed in the form of “(an X coordinate value of an upper left point, a Y coordinate value of an upper left point)−(an X coordinate value of a lower right point, a Y coordinate value of a lower right point)”. The X coordinate value is a value on an X axis that is virtually set on the menu screen. Here, the X axis is set from the left end to the right end of the menu screen for each row of icons that are arranged in a horizontal direction such that the right direction is a positive direction. Then, it is assumed that the value of the right end on the X axis that is set for each row is the value of the left end on the X axis that is set in the next row. In other words, in terms of the example of FIG. 2A, although the left end of the icon #4 rather than the right end of the icon #3 is actually on the left side, the X coordinate value of the left end of the icon #4 rather than the X coordinate value of the right end of the icon #3 on the X axis is on the larger side (right side). Further, the Y coordinate value is a value on a Y axis that is virtually set on the menu screen. Here, the Y axis is set from the upper end to the lower end for each row of icons that are arranged in the horizontal direction such that the down direction is a positive direction. Then, it is assumed that the values of the upper ends on the Y axes that are set for respective rows are identical and the values of the lower end on the Y axes that are set for respective rows are identical. In other words, in terms of the example of FIG. 2A, although the upper end of the icon #4 rather than the upper end of the icon #1 is actually on the lower side, if it is assumed that all of the icons have the same size and shapes, the Y coordinate value of the upper end of the icon #1 and the Y coordinate value of the upper end of the icon #4 on the Y axis are the same.

The type is the type of function assigned to the icon. Here, the examples of the function include a printer function, a scan function, a copy function, a facsimile function and the like, but are not limited thereto. The icon is adapted to start the assigned function by being pressed. In FIG. 4, the specific content of the type is omitted.

The design is the picture or the pattern of icons. The design may be selected from plural designs which are prepared in advance. Specifically, a design ID is assigned to each of the plural designs, and the design ID of the design that is selected from the plural designs may be held as a design. In FIG. 4, the specific content of the design is omitted.

The name is the name of the icon. The name of the icon may be set by the user, for example, when an icon is added. In FIG. 4, the specific content of the name is omitted.

### First Exemplary Embodiment

Outline

(a) to (d) of FIG. 5 are diagrams illustrating an outline of a first exemplary embodiment. In the first exemplary embodiment, a copy icon that is generated by copying the original icon, which is a copy target icon arranged on the menu screen 30, is added in a position adjacent to a predetermined side of the original icon. Since the original icon is regarded as an icon that is a reference at the time of adding the copy icon, the original icon is an example of a reference display element as a reference. Further, the copy icon is an icon that takes over the information of the original icon. Here, it is assumed that another icon that takes over the application (function) that is assigned to the original icon and is obtained by changing some parameters used in its application is generated as a copying icon. In other words, the “copy” as used herein means copying a function assigned to an icon and the parameters that are set in the icon. When the function assigned to the icon is a copy function, the copy function and parameters that are set in the copy function are copied. For example, a new icon is generated by copying an aggregation setting for forming an image that has been read from plural sheets on the surface of one sheet, a setting of the reading resolution of the scanner, and the like. Further, when the function assigned to the icon is scan function, a scan function and parameters that are set in the scan function are copied. For example, a new icon is generated by copying a setting of a storage destination of data obtained by scanning, the setting of the reading resolution of the scanner, and the like.

First, as illustrated in (a) of FIG. 5, the user selects an original icon. Here, an icon #A corresponding to A application is selected as the original icon. Thus, as illustrated in (b) of FIG. 5, a setting screen 36 of a copy icon is displayed. Here, the setting screen 36 of the A application is displayed. Therefore, it is assumed that the user perform the setting of the A application and presses “Save setting” button 37. Then, as illustrated in (c) of FIG. 5, a setting save screen 38 of a copy icon is displayed. Here, the setting save screen 38 of the A application is displayed. Therefore, it is assumed that the user presses a “save as” button 39. Then, as illustrated in (d) of FIG. 5, a copy icon that has been generated by copying the original icon selected in (a) of FIG. 5 is added to a position adjacent to the original icon. Here, a copy icon #A′ corresponding to the A application is arranged in a position in which an icon #3 was arranged. At this time, icons after the icon that was arranged in the position of the added icon are shifted and rearranged. Here, icons after the icon #3 are shifted and rearranged.

Operation

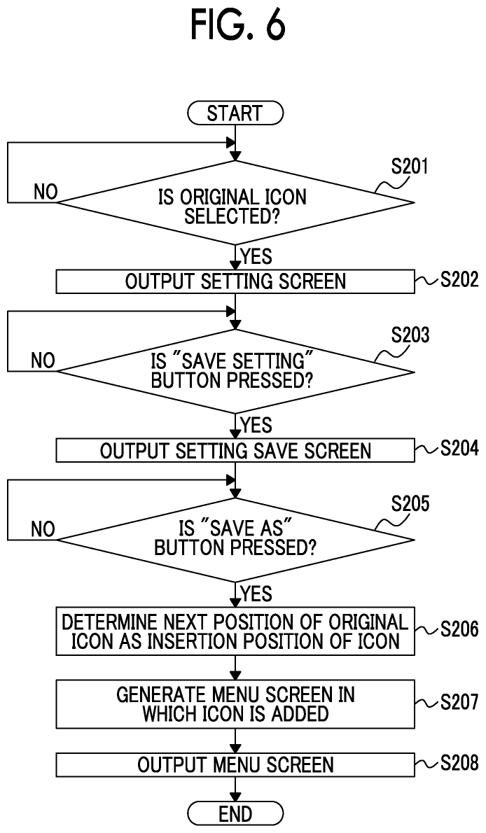

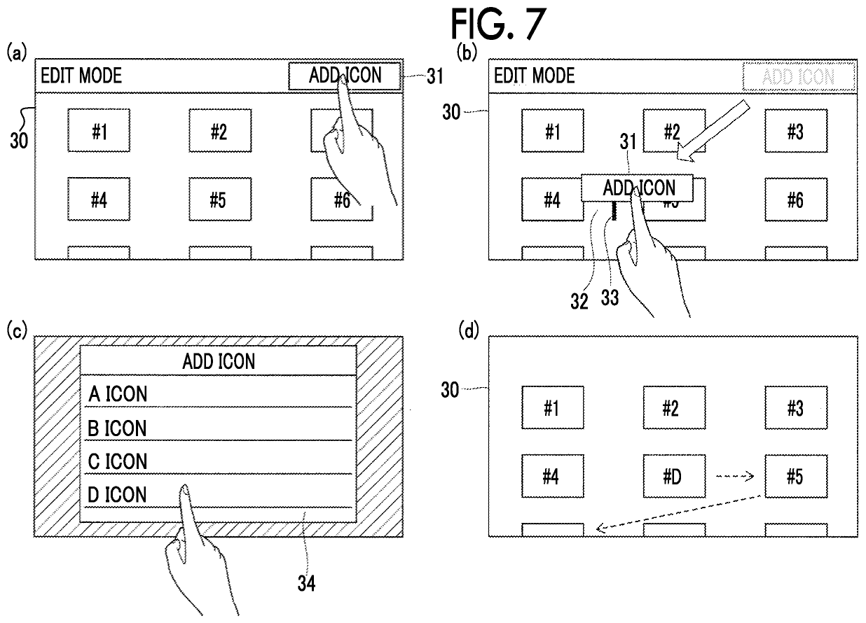

FIG. 6 is a flowchart illustrating an operation example of the screen display apparatus 20 of the first exemplary embodiment. Further, this operation example will be described, assuming the position adjacent to a predetermined side of the original icon as the position adjacent to the right side of the original icon illustrated in (d) of FIG. 5, in other words, the next position of the original icon. Further, the operation example will be described assuming that N icons are first arranged in the menu screen 30 in total.

If the operation is started, in the screen display apparatus 20, first, the operation reception unit 21 determines whether there is an operation to select an original icon on the menu screen 30 displayed on the operation panel 15 (step S201). Here, whether or not there is an operation to select an original icon may be determined, for example, by examining whether or not there is K (K=1, 2, . . . , N) satisfying the condition “XL_{K}≤X≤XR_{K} and YT_{K}≤Y≤YB_{K}”, for the coordinates (X,Y) of the position pressed on the menu screen 30 corresponding to the position pressed on the operation panel 15 and the icon area “(XL_{K}, YT_{K})−(XR_{K}, YB_{K})” of the screen information stored in the screen information storage unit 22. At this time, the operation reception unit 21 holds K satisfying the condition as the icon number of the original icon. Then, if it is determined that there is no such an operation, the operation reception unit 21 repeats step S201. If it is determined that there is such an operation, the control is transferred to the screen output unit 24. Thus, the screen output unit 24 outputs the setting screen 36 for performing the setting for the function corresponding to the copy icon to the operation panel 15 (step S202). Then, the user performs the setting for the function corresponding to the copy icon on the setting screen 36.

Next, the operation reception unit 21 determines whether there is an operation to press a “Save setting” button 37 on the setting screen 36 (step S203). Then, if it is determined that there is no such an operation, the operation reception unit 21 repeats step S203. If it is determined that there is such an operation, the control is transferred to the screen output unit 24. Thus, the screen output unit 24 outputs the setting save screen 38 for saving the setting for the function corresponding to the copy icon to the operation panel 15 (step S204).

Next, the operation reception unit 21 determines whether there is an operation to press a “Save as” button 39 on the setting save screen 38 (step S205). Then, if it is determined that there is no such an operation, the operation reception unit 21 repeats step S205. If it is determined that there is such an operation, the control is transferred to the screen output unit 24.

Thus, the screen generation unit 23 determines the position of the next icon of the original icon on the menu screen 30 to the insertion position of the copy icon (step S206). Specifically, since the operation reception unit 21 holds the icon number K of the original icon in step S201, the screen generation unit 23 receives the icon number K from the operation reception unit 21, and determines the next icon number (K+1) of the icon number K to the icon number of the insertion position of the copy icon.

Further, the screen generation unit 23 generates a new menu screen 30 in which an icon is added (step S207). Specifically, first, the screen information stored in the screen information storage unit 22 is updated such that the information of the icon number (K+1) to the icon number N becomes the information of the icon number (K+2) to the icon number (N+1) as its order. Further, information on the copy icon is updated so as to be information of the icon number (K+1). Further, a new menu screen 30 is generated based on the updated screen information.

Thereafter, the screen output unit 24 outputs the new menu screen 30 to the operation panel 15 (step S208).

In addition, in the first exemplary embodiment, when the icon of the last position in the displayed portion of the menu screen 30 is copied, the copy icon is added to the non-displayed portion of the menu screen 30, but the added icon may not be displayed at it is, or may be displayed by changing the displayed portion of the menu screen 30.

### Second Exemplary Embodiment

Outline

(a) to (d) of FIG. 7 are diagrams illustrating the outline of the second exemplary embodiment. In the second exemplary embodiment, a position is determined, to which an icon is added, by dragging the “Add icon” button 31.

First, as illustrated in (a) of FIG. 7, the user press-holds and starts dragging the “Add icon” button 31, in the edit mode of the menu screen 30. Next, as illustrated in (b) of FIG. 7, the user designates the insertion position of an icon, by dragging the “Add icon” button 31. Further, the “Add icon” button 31 is an example of an addition operation display element for an operation of adding a new display element. Here, the margin portion 32 between the icon #4 and the icon #5 is designated as the insertion position of an icon. Further, at this time, the insertion bar 33 may be displayed in the insertion position of the icon. When the user releases the finger in this state, the drag of the “Add icon” button 31 is released, and the insertion position of the icon is determined. Then, as illustrated in (c) of FIG. 7, the icon adding screen 34 is displayed on the menu screen 30. Therefore, the user selects the type of an icon that the user wants to add, from the icon types on the icon adding screen 34. Here, D icon is selected as the icon type. Then, as illustrated in (d) of FIG. 7, the icon type selected in (c) of FIG. 7 is inserted to the insertion position that is designated in (b) of FIG. 7. Here, the icon #D of which the icon type is D icon is arranged in the position in which the icon #5 was arranged. At this time, the icons after the icon that was arranged in the position of the added icon are shifted and rearranged. Here, the icons after the icon #5 are shifted and rearranged.

Operation

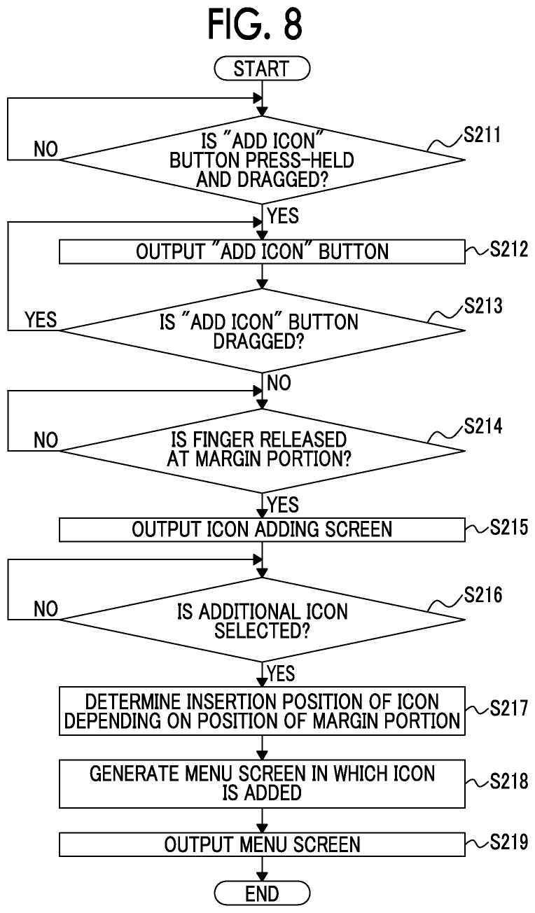

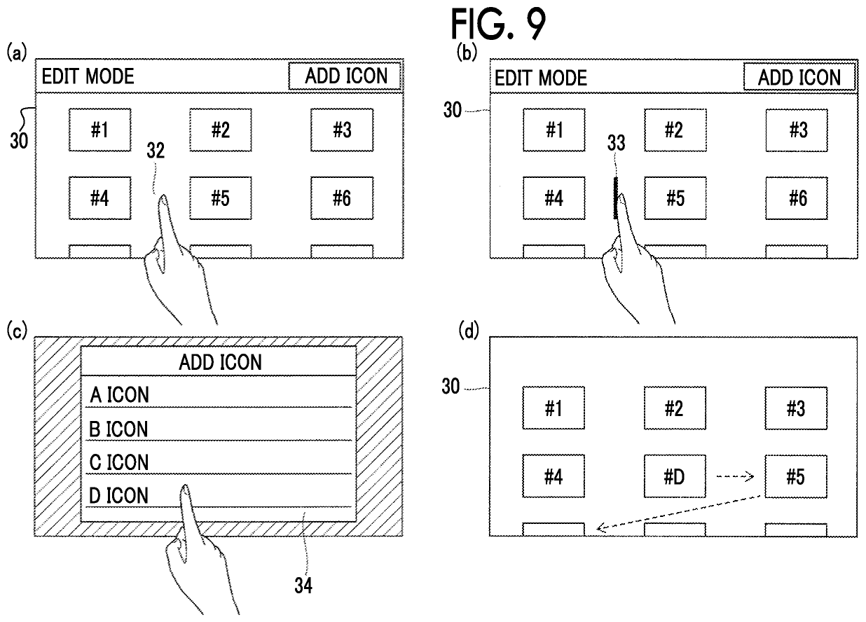

FIG. 8 is a flowchart illustrating an operation example of the screen display apparatus 20 of the second exemplary embodiment. Further, the operation example will be described assuming that N icons are first arranged in the menu screen 30 in total.

If the operation is started, in the screen display apparatus 20, first, the operation reception unit 21 determines whether there is an operation to press-hold and drag the “Add icon” button 31 on the menu screen 30 displayed on the operation panel 15 (step S211). Then, if it is determined that there is no such an operation, the operation reception unit 21 repeats step S211. If it is determined that there is such an operation, the control is transferred to the screen output unit 24. Thus, the screen output unit 24 outputs the “Add icon” button 31 to the operation panel 15 so as to be displayed in a drag destination position (step S212).

Next, the operation reception unit 21 determines whether there is an operation to continue dragging the “Add icon” button 31 on the menu screen 30 displayed on the operation panel 15 (step S213). If it is determined that there is such an operation, the operation reception unit 21 transfers the control to the screen output unit 24. Thus, the screen output unit 24 outputs the “Add icon” button 31 to the operation panel 15 so as to be displayed in a drag destination position (step S212).

In contrast, if it determined that there is no operation to continue dragging the “Add icon” button 31, the operation reception unit 21 determines whether there is a user's operation of releasing the finger at the margin portion 32 (step S214). Here, whether or not there is a user's operation of releasing the finger at the margin portion 32 may be determined, for example, by examining whether or not there is K (K=1, 2, . . . , N−1) satisfying the condition “XR_{K}≤X≤XL_{K+1}, YT_{K}≤Y≤YB_{K}, and YT_{K+1}≤Y≤YB_{K+1}”, for coordinates (X,Y) of the position pressed on the menu screen 30 corresponding to the position pressed on the operation panel 15 and the icon area “(XL_{K}, YT_{K})−(XR_{K}, YB_{K})” and “(XL_{K+1}, YT_{K+1})−(XR_{K+1}, YB_{K+1})” of the screen information stored in the screen information storage unit 22. Further, at this time, the operation reception unit 21 holds (K, K+1) satisfying the condition as the icon numbers of the icons on both sides of the margin portion 32. Then, if it is determined that there is no such an operation, the operation reception unit 21 repeats step S214. If it is determined that there is such an operation, the control is transferred to the screen output unit 24. Thus, the screen output unit 24 outputs the icon adding screen 34 for selecting the additional icon to the operation panel 15 (step S215).

Next, the operation reception unit 21 determines whether there is an operation to select an additional icon on the icon adding screen 34 (step S216). Then, if it is determined that there is no such an operation, step S216 is repeated. If it is determined that there is such an operation, the control is transferred to the screen generation unit 23.

Thus, the screen generation unit 23 determines the position of the icon of the later order, out of the icons arranged on both sides of the margin portion 32 of the menu screen 30 as the insertion position of the additional icon (step S217). Specifically, since the operation reception unit 21 holds the icon numbers (K, K+1) on both sides of the margin portion 32 in step S214, the screen generation unit 23 receives the icon numbers from the operation reception unit 21, and determines the icon number (K+1) of the later order out of the icon numbers, as the icon number of the insertion position of the additional icon.

Further, the screen generation unit 23 generates a new menu screen 30 in which an icon is added (step S218). Specifically, first, the screen information stored in the screen information storage unit 22 is updated such that the information of the icon number (K+1) to the icon number N becomes the information of the icon number (K+2) to the icon number (N+1) as its order. Further, information on the added icon is updated so as to be information of the icon number (K+1). Further, the new menu screen 30 is generated based on the screen information updated in this manner.

Thereafter, the screen output unit 24 outputs the new menu screen 30 to the operation panel 15 (step S219).

### Third Exemplary Embodiment

Outline

(a) to (d) of FIG. 9 are diagrams illustrating the outline of the third exemplary embodiment. In the third exemplary embodiment, a position is determined, to which an icon is added, by pressing and holding the margin portion 32.

First, as illustrated in (a) of FIG. 9, the user designates the insertion position of an icon, by pressing and holding the margin portion 32 in the edit mode of the menu screen 30. Here, the margin portion 32 between the icon #4 and the icon #5 is designated as the insertion position of an icon. Further, in the present exemplary embodiment, the margin portion 32 is pressed and held, but this operation is an example of an operation to press the position to add a new display element, and another press operation may be employed. Further, at this time, as illustrated in (b) of FIG. 9, the insertion bar 33 is displayed in the insertion position of the icon. If the user drags the finger, the insertion position is changed. At this time, the change of the insertion position may be seen by moving the insertion bar 33. If the user releases the finger in this state, the drag of the insertion bar 33 is released, and the insertion position of the icon is determined. Then, as illustrated in (c) of FIG. 9, an icon adding screen 34 is displayed on the menu screen 30. Therefore, the user selects the type of an icon that the user wants to add, from the icon types on the icon adding screen 34. Here, D icon is selected as the icon type. Then, as illustrated in (d) of FIG. 9, the icon type selected in (c) of FIG. 9 is inserted to the insertion position that is designated in (b) of FIG. 9. Here, the icon #D of which the icon type is D icon is arranged in the position in which the icon #5 was arranged. At this time, the icons after the icon that was arranged in the position of the added icon are shifted and rearranged. Here, the icons after the icon #5 are shifted and rearranged.

Operation

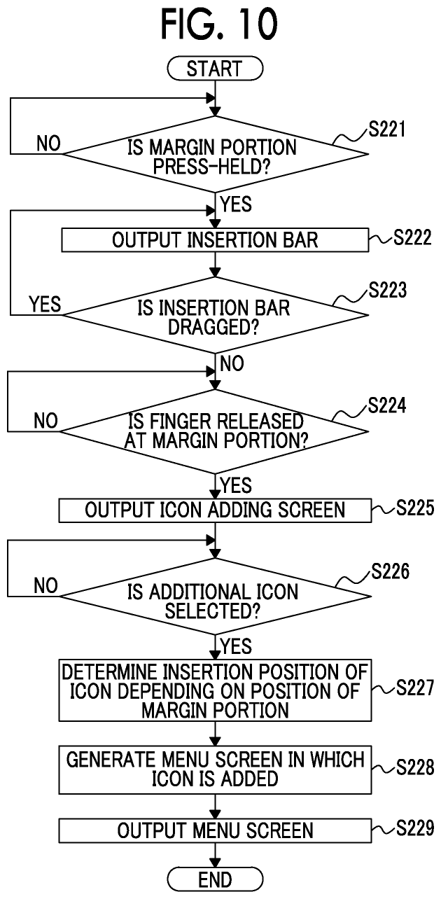

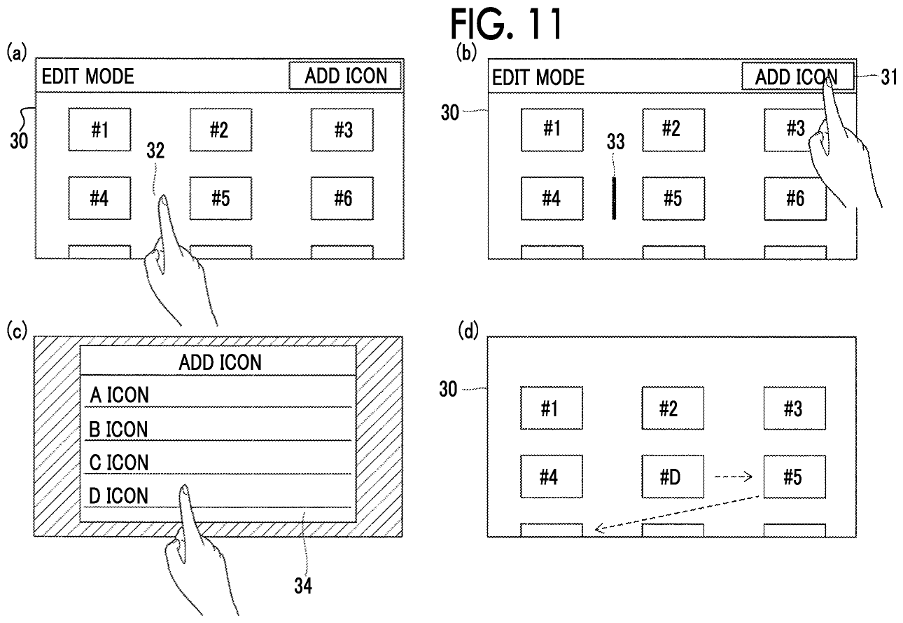

FIG. 10 is a flowchart illustrating an operation example of the screen display apparatus 20 of the third exemplary embodiment.

If the operation is started, in the screen display apparatus 20, first, the operation reception unit 21 determines whether there is an operation to press and hold the margin portion 32 on the menu screen 30 displayed on the operation panel 15 (step S221). Then, if it is determined that there is no such an operation, the operation reception unit 21 repeats step S221. If it is determined that there is such an operation, the control is transferred to the screen output unit 24. Thus, the screen output unit 24 outputs the insertion bar 33 to the operation panel 15 so as to be displayed in a drag destination position (step S222).

Next, the operation reception unit 21 determines whether there is an operation to drag the insertion bar 33 on the menu screen 30 displayed on the operation panel 15 (step S223). Then, if it is determined that there is such an operation, the operation reception unit 21 transfers the control to the screen output unit 24. Thus, the screen output unit 24 outputs the insertion bar 33 to the operation panel 15 so as to be displayed in a drag destination position (step S222).

In contrast, if the operation reception unit 21 determines that there is no operation to drag the insertion bar 33, the screen display apparatus 20 performs the processes of steps S224 to S229. Since these processes are the same as the processes of steps S214 to S219 of FIG. 8, the description thereof will be omitted.

### Fourth Exemplary Embodiment

Outline

(a) to (d) of FIG. 11 are diagrams illustrating the outline of the fourth exemplary embodiment. In the fourth exemplary embodiment, a position is determined, to which an icon is added by tapping the margin portion 32 once.

First, as illustrated in (a) of FIG. 11, the user designates the insertion position of an icon, by tapping the margin portion 32 once in the edit mode of the menu screen 30. Here, the margin portion 32 between the icon #4 and the icon #5 is designated as the insertion position of an icon. Further, in the present exemplary embodiment, the margin portion 32 is tapped once, but this operation is an example of an operation to press the position to add a new display element, and another press operation may be employed. Further, at this time, as illustrated in (b) of FIG. 11, the insertion bar 33 is displayed in the insertion position of the icon. If the user presses the “Add icon” button 31 in this state, the insertion position of the icon is determined. Then, as illustrated in (c) of FIG. 11, the icon adding screen 34 is displayed on the menu screen 30. Therefore, the user selects the type of an icon that the user wants to add, from the icon types on the icon adding screen 34. Here, D icon is selected as the icon type. Then, as illustrated in (d) of FIG. 11, the icon type selected in (c) of FIG. 11 is inserted to the insertion position that is designated in (b) of FIG. 11. Here, the icon #D of which the icon type is D icon is arranged in the position in which the icon #5 was arranged. At this time, the icons after the icon that was arranged in the position of the added icon are shifted and rearranged. Here, the icons after the icon #5 are shifted and rearranged.

Operation

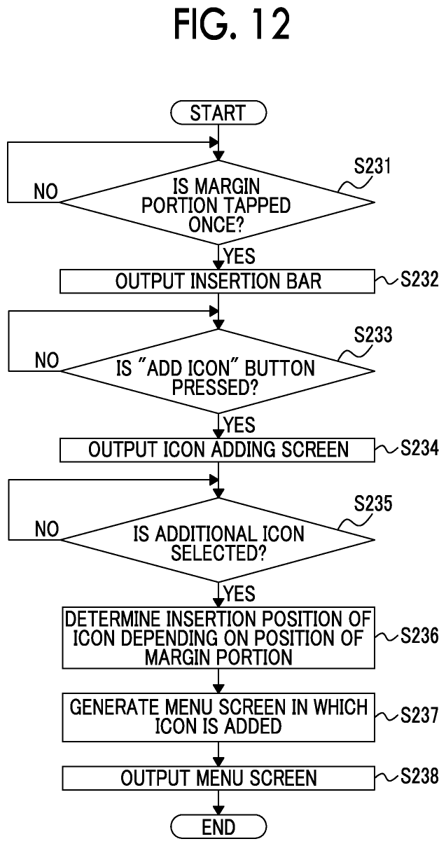

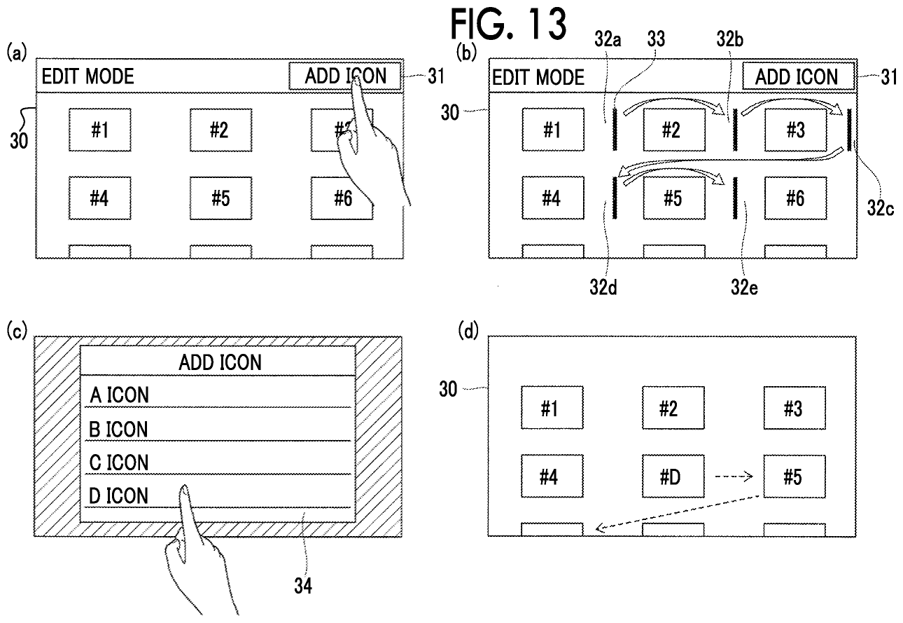

FIG. 12 is a flowchart illustrating an operation example of the screen display apparatus 20 of the fourth exemplary embodiment.

If the operation is started, in the screen display apparatus 20, first, the operation reception unit 21 determines whether there is an operation to tap the margin portion 32 once on the menu screen 30 displayed on the operation panel 15 (step S231). Here, whether or not the margin portion 32 is single-tapped may be determined, for example, by examining whether or not there is K (K=1, 2, . . . , N) satisfying the condition “XR_{K}≤X≤XL_{K+1}, YT_{K}≤Y≤YB_{K}”, and YT_{K+1}≤Y≤YB_{K+1}”, for the coordinates (X,Y) of the position pressed on the menu screen 30 corresponding to the position pressed on the operation panel 15 and the icon area “(XL_{K}, YT_{K})−(XR_{K}, YB_{K})” and “(XL_{K+1}, YT_{K+1})−(XR_{K+1}, YB_{K+1})” of the screen information stored in the screen information storage unit 22. At this time, the operation reception unit 21 holds (K, K+1) satisfying the condition as the icon number of the icons on both sides of the margin portion 32. Then, if it is determined that there is no such an operation, the operation reception unit 21 repeats step S231. If it is determined that there is such an operation, the control is transferred to the screen output unit 24. Thus, the screen output unit 24 outputs the insertion bar 33 to the operation panel 15 so as to be displayed in a position that is tapped once (step S232).

Next, the operation reception unit 21 determines whether there is an operation to press the “Add icon” button 31 on the menu screen 30 displayed on the operation panel 15 (step S233). Then, if it is determined that there is no such an operation, the operation reception unit 21 repeats step S233. Further, if the operation reception unit 21 determines that there is such an operation, the screen display apparatus 20 performs the processes of steps S234 to S238. Since these processes are the same as the processes of steps S215 to S219 of FIG. 8 except for that (K, K+1) used for determining the insertion position of the additional icon is held in step S231, the description thereof will be omitted.

### Fifth Exemplary Embodiment

Outline

(a) to (d) of FIG. 13 are diagrams illustrating the outline of the fifth exemplary embodiment. In the fifth exemplary embodiment, a position is determined, to which an icon is added, by selecting the position of the insertion bar 33 which moves sequentially.

First, as illustrated in (a) of FIG. 13, the user presses the “Add icon” button 31 in the edit mode of the menu screen 30. Then, as illustrated in (b) of FIG. 13, the insertion bar 33 is displayed in the candidates for the insertion position of the icon, sequentially. Further, the insertion bar 33 is an example of addition-possible position display element indicating a position in which a new display element may be added. Here, the display position of the insertion bar 33 is switched between the margin portion 32a between the icon #1 and the icon #2, the margin portion 32b between the icon #2 and the icon #3, the margin portion 32c on the right side of icon #3, the margin portion 32d between the icon #4 and the icon #5, and the margin portion 32e between the icon #5 and the icon #6, in this order. In a state where the insertion bar 33 is displayed in the position in which the user wants to add an icon, if the user presses the “Add icon” button 31, the insertion position of the icon is designated. Further, the “Add icon” button 31 is an example of an addition operation display element for an operation of adding a new display element. Here, it is assumed that the “Add icon” button 31 is pressed in a state where the insertion bar 33 is displayed in the margin portion 32d between the icon #4 and icon #5, and the margin portion 32d is designated as the insertion position of the icon. Then, as illustrated in (c) of FIG. 13, the icon adding screen 34 is displayed on the menu screen 30. Therefore, the user selects the type of an icon that the user wants to add, from the icon types on the icon adding screen 34. Here, D icon is selected as the icon type. Then, as illustrated in (d) of FIG. 13, the icon type selected in (c) of FIG. 13 is inserted to the insertion position that is designated in (b) of FIG. 13. Here, the icon #D of which the icon type is D icon is arranged in the position in which the icon #5 was arranged. At this time, the icons after the icon that was arranged in the position of the added icon are shifted and rearranged. Here, the icons after the icon #5 are shifted and rearranged.

Operation

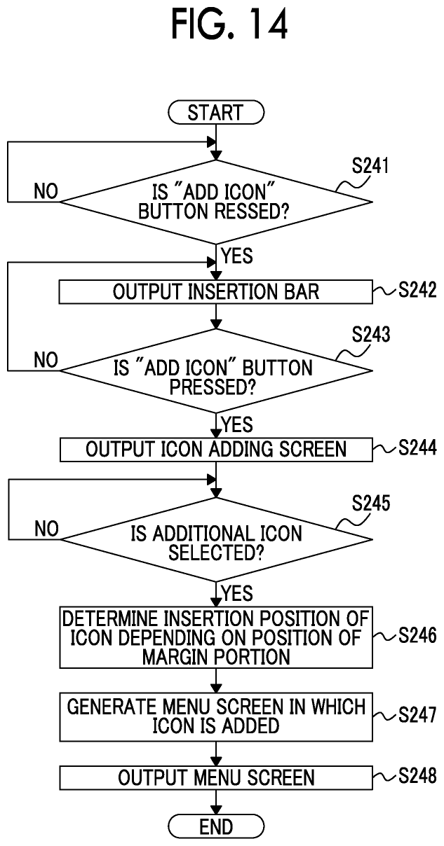

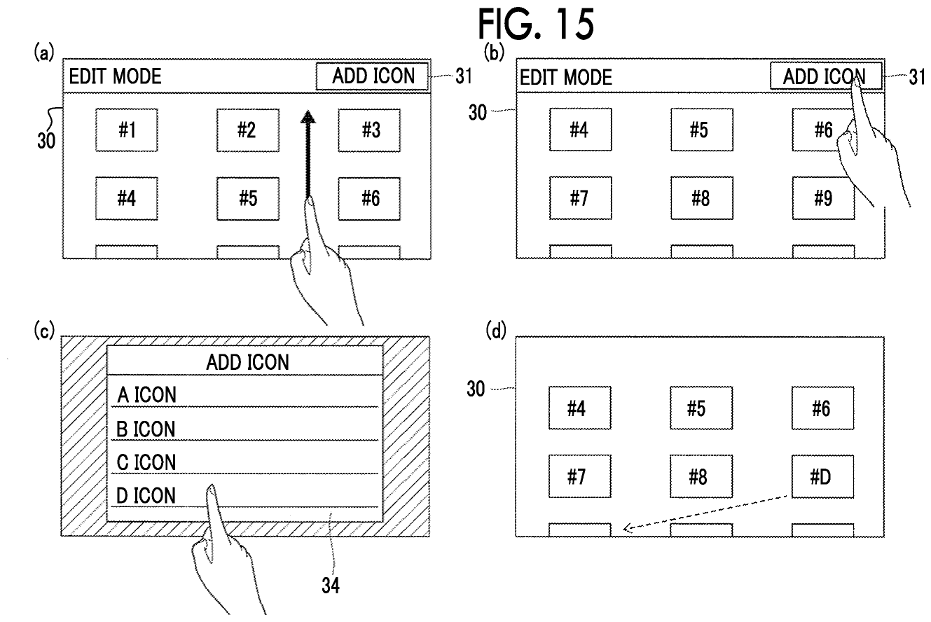

FIG. 14 is a flowchart illustrating an operation example of the screen display apparatus 20 of the fifth exemplary embodiment.

If the operation is started, in the screen display apparatus 20, first, the operation reception unit 21 determines whether there is an operation to press the “Add icon” button 31 on the menu screen 30 displayed on the operation panel 15 (step S241). Then, if it is determined that there is no such an operation, the operation reception unit 21 repeats step S241. If it is determined that there is such an operation, the control is transferred to the screen output unit 24. Thus, the screen output unit 24 outputs the insertion bar 33 to the operation panel 15 so as to be displayed in the margin portion 32 that is to be first displayed (step S242).

Next, the operation reception unit 21 determines whether there is an operation to press the “Add icon” button 31 on the menu screen 30 displayed on the operation panel 15 (step S243). Then, if it is determined that there is no such an operation, the operation reception unit 21 transfers the control to the screen output unit 24. Thus, the screen output unit 24 outputs the insertion bar 33 to the operation panel 15 so as to be displayed in a margin portion 32 that is determined depending on a time that has been elapsed after the insertion bar 33 was displayed in the margin portion 32 that is to be first displayed (step S242). Here, the margin portion 32 where the insertion bar 33 is present may be specified, for example, by obtaining K (K=1, 2, . . . , N−1) satisfying the condition “XR_{K}≤X≤XL_{K+1}, YT_{K}≤Y≤YB_{K}, and YT_{K+1}≤Y≤YB_{K+1}”, for coordinates (X,Y) of the position pressed on the menu screen 30 corresponding to the position pressed on the operation panel 15 and the icon area “(XL_{K}, YT_{K})−(XR_{K}, YB_{K})” and “(XL_{K+1}, YT_{K+1})−(XR_{K+1}, YB_{K+1})” of the screen information stored in the screen information storage unit 22. Further, at this time, the screen output unit 24 holds (K, K+1) satisfying the condition as the icon numbers of the icons on both sides of the margin portion 32.

Meanwhile, if the operation reception unit 21 determines that there is an operation to press the “Add icon” button 31, the screen display apparatus 20 performs the processes of steps S244 to S248. Since these processes are the same as the processes of steps S215 to S219 of FIG. 8 except for that (K, K+1) used for determining the insertion position of the additional icon has been held immediately before step S242, the description thereof will be omitted.

Further, in the fifth exemplary embodiment, the display position of the insertion bar 33 is the margin portion 32e between the icon #5 and the icon #6 such that an icon is added to the displayed portion of the menu screen 30. However, the display position of the insertion bar 33 may be the margin portion on the right side of the icon #6. In this case, the icon is added to the non-displayed portion of the menu screen 30, but the added icon may not be displayed at it is, or may be displayed by changing the displayed portion of the menu screen 30. Further, the display position of the insertion bar 33 may be expanded up to the margin portion after the icon #7, and the display position of the insertion bar 33 may be switched while changing the displayed portion of the menu screen 30 such that the insertion bar 33 is visible.

### Sixth Exemplary Embodiment

Outline

(a) to (d) of FIG. 15 are diagrams illustrating an outline of a sixth exemplary embodiment. In the sixth exemplary embodiment, an icon is added to a predetermined position in the displayed portion of the menu screen 30. Further, the displayed portion of the menu screen 30 is an example of a display element group which is a group of display element arranged adjacent to each other.

First, as illustrated in (a) of FIG. 15, the user scrolls a screen by flicking the screen such that a portion of the menu screen 30 that the user wants to add an icon is displayed. Here, a case is illustrated in which a portion is displayed in which the icons #4 to #9 are arranged by the flick in a state where a portion is displayed in which the icons #1 to #6 are arranged. Next, as illustrated in (b) of FIG. 15, the user presses the “Add icon” button 31. Thus, as illustrated in (c) of FIG. 15, the icon adding screen 34 is displayed on the menu screen 30. Therefore, the user selects the type of an icon that the user wants to add, from the types of the icons of the icon adding screen 34. Here, D icon is selected as the type of an icon. Thus, as illustrated in (d) of FIG. 15, the icon of the type selected in (c) of FIG. 15 is inserted in, for example, the last position of the displayed portion of the menu screen 30. Here, the icon #D of which the icon type is D icon is arranged in the position in which the icon #9 was arranged. At this time, icons after the icon that was arranged in the position of the added icon are shifted and rearranged. Here, icons after the icon #9 are shifted and rearranged.

Further, with respect to the sixth exemplary embodiment, a modification example is considered in which an icon is inserted, for example, in the last position of the displayed portion of the menu screen 30 and the layout change of the other icons is minimized. The modification example is the same as the above-described embodiment up to the process in which the icon is inserted in (d) of FIG. 15. However, at this time, the icon that was placed in the position of the added icon is moved to and rearranged in the last position (an icon is not displayed) of the menu screen 30. In the example of (a) to (d) of FIG. 15, the icon #9 is moved to and rearranged in the last position of the menu screen 30. Thus, with respect to the icons after the icon #10, the positions are not changed and the layout is maintained.

Operation

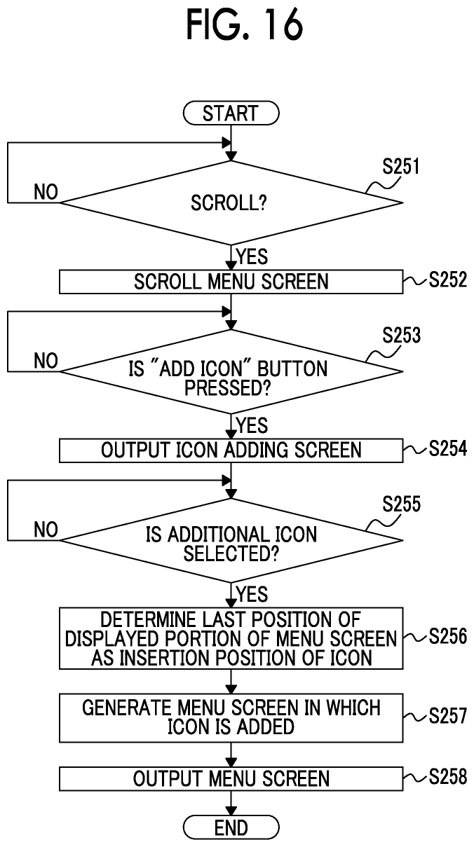

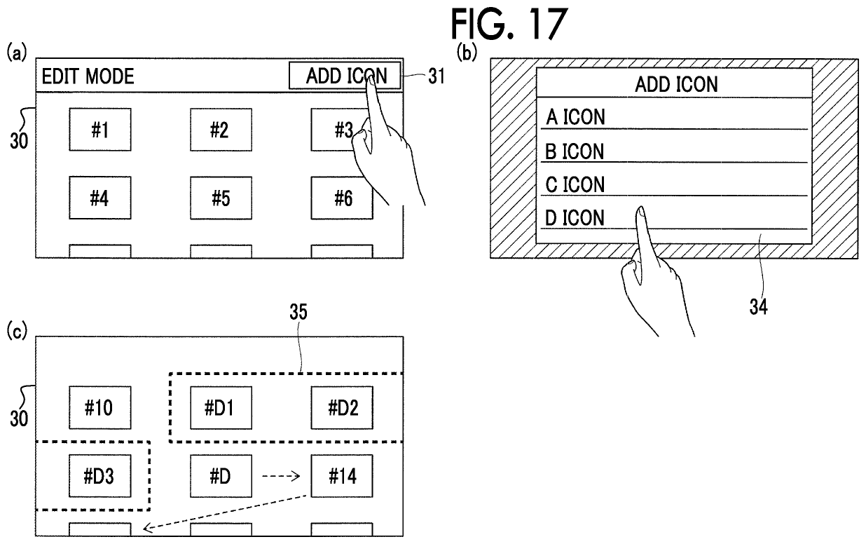

FIG. 16 is a flowchart illustrating an operation example of the screen display apparatus 20 of the sixth exemplary embodiment. Further, this operation example will be described assuming a predetermined position within the displayed portion of the menu screen 30 as the last position of the displayed portion of the menu screen 30 illustrated in (d) of FIG. 15. Further, the case will be described in which the icons after the icon that was arranged in the last position of the displayed portion of the menu screen 30 are shifted and rearranged as illustrated in (d) of FIG. 15. Further, the operation example will be described assuming that N icons are first arranged in the menu screen 30 in total.

If the operation is started, in the screen display apparatus 20, first, the operation reception unit 21 determines whether there is an operation to scroll the menu screen 30 displayed on the operation panel 15 (step S251). Then, if it is determined that there is no such an operation, the operation reception unit 21 repeats step S251. If it is determined that there is such an operation, the control is transferred to the screen output unit 24. Thus, the screen output unit 24 scrolls and outputs the menu screen 30 to the operation panel 15 (step S252). At this time, the screen output unit 24 holds the icon number M of the last icon in the displayed portion of the menu screen 30.

Next, the operation reception unit 21 determines whether there is an operation to press the “Add icon” button 31 on the menu screen 30 displayed on the operation panel 15 (step S253). Then, if it is determined that there is no such an operation, the operation reception unit 21 repeats step S253. If it is determined that there is such an operation, the control is transferred to the screen output unit 24. Thus, the screen output unit 24 outputs the icon adding screen 34 for selecting an additional icon to the operation panel 15 (step S254).

Next, the operation reception unit 21 determines whether there is an operation to select an additional icon on the icon adding screen 34 (step S255). Then, if it is determined that there is no such an operation, step S255 is repeated; and if it is determined that there is such an operation, the control is transferred to the screen generation unit 23.

Thus, the screen generation unit 23 determines the position of the last icon of the displayed portion of the menu screen 30 as the insertion position of the additional icon (step S256). Specifically, since the screen output unit 24 holds the icon number M of the last icon of the displayed portion of the menu screen 30 in step S252, the screen generation unit 23 receives the icon numbers from the screen output unit 24, and determines the icon number M as the icon number of the insertion position of the additional icon.

Further, the screen generation unit 23 generates a new menu screen 30 in which an icon is added (step S257). Specifically, first, the screen information stored in the screen information storage unit 22 is updated such that the information of the icon number M to the icon number N becomes the information of the icon number (M+1) to the icon number (N+1) as its order. Further, information on the additional icon is updated so as to become information of the icon number M. Further, the new menu screen 30 is generated based on the screen information updated in this manner.

Thereafter, the screen output unit 24 outputs the new menu screen 30 to the operation panel 15 (step S258).

### Seventh Exemplary Embodiment

Outline

(a) to (c) of FIG. 17 are diagrams illustrating the outline of the seventh exemplary embodiment. In the seventh exemplary embodiment, an icon is added to a position adjacent to a predetermined side in an icon group with an attribute having a predetermined relationship with the attribute of the icon. Here, the attribute is, for example, a type, a design, and a name, and the predetermined relationship is the same or similar relationship. In other words, in this exemplary embodiment, for example, an icon is added to the position adjacent to the icon group of the same type and the same design as the icon and the name similar to the icon. Further, the icon group with an attribute having a predetermined relationship with the attribute of the icon is an example of a display element group that is a group of display elements arranged adjacent to each other.

First, as illustrated in (a) of FIG. 17, the user presses the “Add icon” button 31. Thus, as illustrated in (b) of FIG. 17, the icon adding screen 34 is displayed on the menu screen 30. Therefore, the user selects the type of an icon that the user wants to add, from the types of the icons of the icon adding screen 34. Here, D icon is selected as the type of an icon. Then, as illustrated in (c) of FIG. 17, the icon of the type selected in (b) of FIG. 17 is added, for example, to the next position of the icon group of the same type. Here, as “the icon group of the same type”, the icon group having the same types of functions such as a copy function assigned to the icon and a facsimile function is exemplified. For example, the icon group assigned to the copy function “Copy1”, “Eco Copy”, “Color Copy”, and “Tom's Copy” corresponds to the “icon group of the same type”. Here, the icon #D of which the icon type is D icon is added after the region 35 in which the icons #D1, #D2, and #D3 are fixedly arranged. At this time, icons after the icon that was arranged in the position of the added icon are shifted and rearranged. Here, icons after the icon #14 are shifted and rearranged.

Further, if the design of the icon may be selected in (b) of FIG. 17, the icon of the selected design may be added, for example, to the next position of the icon group of the same design. Further, if the name of the icon may be determined in (b) of FIG. 17, the icon of the determined name may be added, for example, to the next position of the icon group of the similar name. Here, the icon group of the name of the same word is exemplified as “the icon group of the similar name”. For example, the icon group “Tom's Copy”, “Tom's FAX1”, “Tom's FAX2”, “Tom's Scan”, and the icon group “FAX1”, “Fax2”, “FAX35”, and “Fax100” correspond to “the icon group of the similar name”.

Further, in the seventh exemplary embodiment, when the icon is added, the icon group of the icon that the user wants to add may not necessarily be displayed. In other words, as the sixth exemplary embodiment, when the icon is added, it is not necessary to scroll a screen for displaying the portion to which the user wants to add the icon on the menu screen 30, and the icon may be added in a state in which any part is displayed on the menu screen 30. However, after the icon is added, the icon group to which the icon is added may be displayed.

Operation

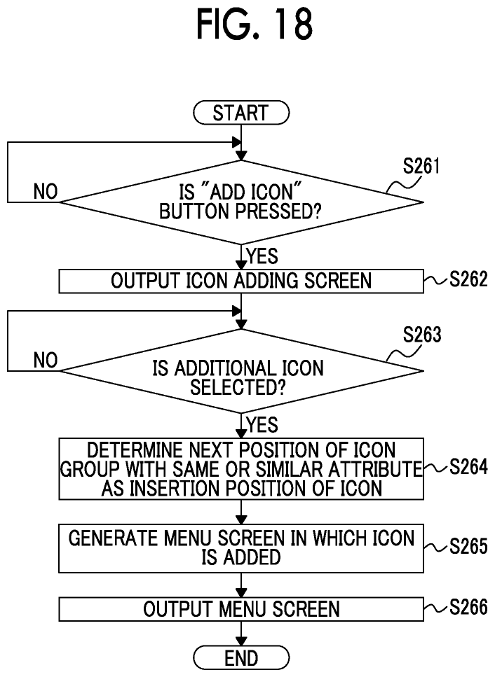

FIG. 18 is a flowchart illustrating an operation example of the screen display apparatus 20 of the seventh exemplary embodiment. Further, in this operation example, the position adjacent to a predetermined side in the icon group is described as the position adjacent to the right side in the icon group illustrated in (c) of FIG. 17, in other words, the next position of the icon group. Further, the operation example will be described assuming that N icons are first arranged in the menu screen 30 in total. Further, it is assumed that the icons having the same attribute among the N icons are already arranged together as an icon group, for example, by the user performing an operation to change the arrangement of an icon.

If the operation is started, in the screen display apparatus 20, first, the operation reception unit 21 determines whether there is an operation to press the “Add icon” button 31 on the menu screen 30 displayed on the operation panel 15 (step S261). Then, if it is determined that there is no such an operation, the operation reception unit 21 repeats step S261. If it is determined that there is such an operation, the control is transferred to the screen output unit 24. Thus, the screen output unit 24 outputs the icon adding screen 34 for selecting an additional icon to the operation panel 15 (step S262).

Next, the operation reception unit 21 determines whether there is an operation to select an additional icon on the icon adding screen 34 (step S263). If it is determined that there is no such an operation, step S263 is repeated; and if it is determined that there is such an operation, the control is transferred to the screen generation unit 23. Further, it is assumed that the attribute of an icon is associated with the additional icon. If the attribute is a type, the attribute may be associated in advance with the additional icon. If the attribute is a design or a name, the attribute may be associated in response to the user's instruction, when the additional icon is added.

Thus, the screen generation unit 23 determines the next position of the icon group with the same or similar attribute as the additional icon on the menu screen 30, as the insertion position of the additional icon (step S264). Specifically, first, the icon number M of the last icon in a sequence of icons with the same attribute is obtained with reference to the screen information stored in the screen information storage unit 22. Here, if the attribute is a type, the sequence of icons with the same attribute is, for example, a sequence of icons of the same type; if the attribute is a design, the sequence is, for example, a sequence of icons of the same design; and if the attribute is a name, the sequence is, for example, a sequence of icons of the similar name. Here, the next icon number (M+1) of the obtained icon number M is determined as the icon number of the insertion position of the additional icon.

Further, the screen generation unit 23 generates a new menu screen 30 in which an icon is added (step S265). Specifically, first, the screen information stored in the screen information storage unit 22 is updated such that the information of the icon number M+1 to the icon number N becomes the information of the icon number (M+2) to the icon number (N+1) as its order. Further, information on the additional icon is updated so as to become information of the icon number (M+1). Further, the new menu screen 30 is generated based on the screen information updated in this manner.

Thereafter, the screen output unit 24 outputs the new menu screen 30 to the operation panel 15 (step S266).

Further, in the seventh exemplary embodiment, the additional icon is added to a position adjacent to a predetermined side in an icon group with an attribute having a predetermined relationship with the attribute of the additional icon, but the present exemplary embodiment is not limited thereto. For example, the concept of the icon group is eliminated from the seventh exemplary embodiment, and the additional icon may be simply added to a position adjacent to a predetermined side of an icon with an attribute having a predetermined relationship with the attribute of the additional icon. In this case, since the icon with an attribute having a predetermined relationship with the attribute of the additional icon is regarded as the icon that is a reference when the additional icon is added, the icon is an example of a reference display element as a reference. Further, if the seventh exemplary embodiment is regarded as described above, even if the user does not perform an operation to arrange the icons with the same attribute among icons arranged in the menu screen 30, as an icon group, the icons with the same attribute are arranged as an icon group, by repeating a process of adding an icon.

Program

A process performed by the screen display apparatus 20 in the present exemplary embodiment is prepared as a program such as, for example, application software.

In other words, a program for realizing the present exemplary embodiment is regarded as a program causing a computer to realize a function of receiving an addition instruction operation to instruct addition of a new display element to a screen in which plural display elements are arranged, and a function of displaying when the addition instruction operation is received, the screen in which the new display element is added in a position adjacent to a predetermined side of a reference display element, the reference display element being a display element which is a reference among the plural display elements.

Further, a program for realizing the present exemplary embodiment is regarded as a program causing a computer to realize a function of receiving a position designation operation to designate a position to add a new display element, on a screen in which plural display elements are arranged, and an addition instruction operation to instruct addition of the new display element to the screen, and a function of displaying, when the addition instruction operation is received after the position designation operation is received, the screen in which the new display element is added in a position designated by the position designation operation.

Further, a program for realizing the present exemplary embodiment is regarded as a program causing a computer to realize a function of receiving an addition instruction operation to instruct addition of a new display element to a screen in which plural display elements are arranged, and a function of displaying, when the addition instruction operation is received, the screen in which the new display element is added, in a predetermined position in a display element group that is a group of display elements that are arranged adjacent to each other, among the plural display elements, or a position adjacent to a predetermined side in the display element group.

Further, a program for realizing the present exemplary embodiment is provided by a communication unit, and may be provided by being stored in a recording medium such as a CD-ROM.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process, the process comprising:
displaying a screen in which a plurality of display elements are displayed;
initiating adding a new display element by selecting one of the multiple display elements;
accepting parameters settings for the new display element;
accepting specification of the position to add the new display element including the parameter;
wherein the new display element and one of the selected display elements have same functionality.

2. A non-transitory computer readable medium storing a program causing a computer to execute a process, according to claim 1,
wherein adding the new display element next to one of the selected display elements.

3. A non-transitory computer readable medium storing a program causing a computer to execute a process, according to claim 1,
wherein adding the new display element to the screen where one of the selected display elements is displayed.
